(19) United States
(12) Patent Application Publication
(10) Pub. No.: US 2009/0030849 A1
(43) Pub. Date: Jan. 29, 2009

(54) System to generate report analyzing business entity offering stock for sale

(76) Inventor: Brian L. Hahn, Higley, AZ (US)

Correspondence Address: TOD R NISSLE, PO BOX 55630, PHOENIX, AZ, 85078, US

(21) Appl. No.: 11/827,511

(22) Filed: Jul. 12, 2007

Related U.S. Application Data
(60) Provisional application No. 60/821,548, filed on Aug. 4, 2006.

(51) Int. Cl. G06Q 40/00

(52) U.S. Cl. 705/36 R

(57) ABSTRACT

A business evaluation system generates for a stock investor a financial report that evaluates a business entity offering stock for sale. The system includes a pledge account in which to deposit pledge money; and, a portal including a memory for storing for a plurality of stock investors profile data, and the quantity of money pledged by each stock investor for the business entity. The memory also stores a pledge database containing the total pledge amount for the business entity. The system also includes a computer operably connected to the memory and operable to receive for each stock investor profile data and the amount of money pledged by each stock investor for the business entity, to direct pledge money to the pledge account, and to determine when a threshold amount of pledge money is received for the business entity. The system also includes a system to withdraw pledge money from the pledge account and to generate independently of the business entity an independent completed evaluation report for the business entity when the threshold amount of pledge money is received; and, a system to permit access to the completed independent evaluation report by stock investors that contributed money to the pledge account.

This application claims priority based on provisional patent application Ser. No. 60/281,548, filed Aug. 4, 2006.

This invention pertains to a system of generating for an interested party a report containing information sought by the party.

More particularly, the invention pertains to a system and apparatus to generate a financial report evaluating a business entity that is offering stock or other financial instruments for sale, or that has stock or other financial instruments traded in secondary markets.

Prior to purchasing a corporation's or other business entity's stock or other financial instruments, an investor ordinarily investigates the business entity to evaluate whether it is likely that the value of the financial instrument will hold steady, will increase, or will decrease. A common problem encountered during such investigations is that the financial and other information available concerning the business entity is prepared by the business entity itself and is therefore more likely to be biased or inaccurate.

Accordingly, it would be highly desirable to provide an improved system that would facilitate the investigation of a business entity by a potential investor.

Therefore, it is an object of the instant invention to provide an improved system to generate and distribute an evaluation of a company's financial status and of other facets of the company's operation.

These and other, further and more specific objects and advantages of the invention will be apparent from the following detailed description thereof, taken in conjunction with the drawings, in which:

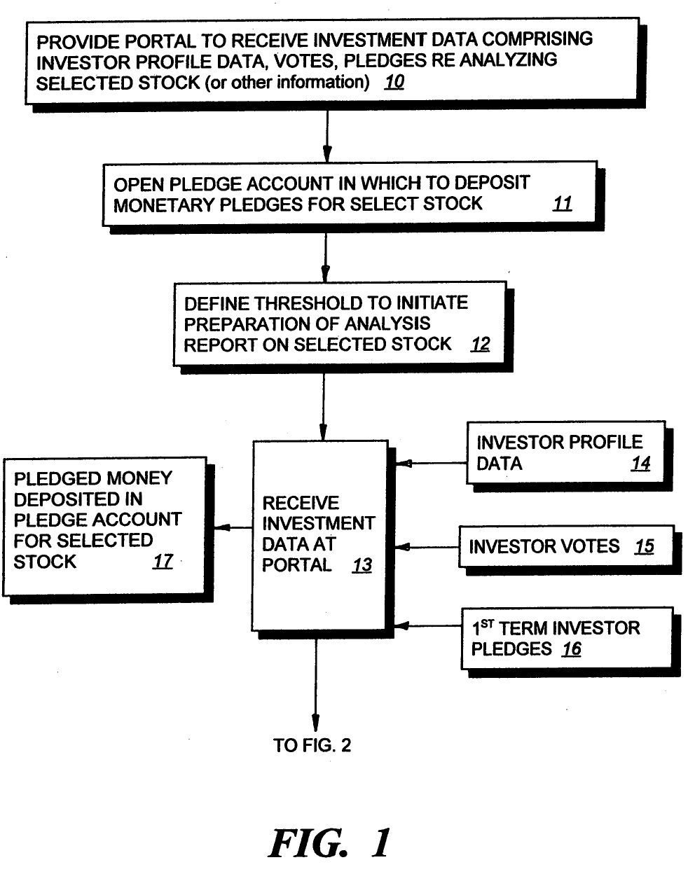

FIG. 1 is a block flow diagram illustrating a system to generate an evaluation of the operation and financial status of a company;

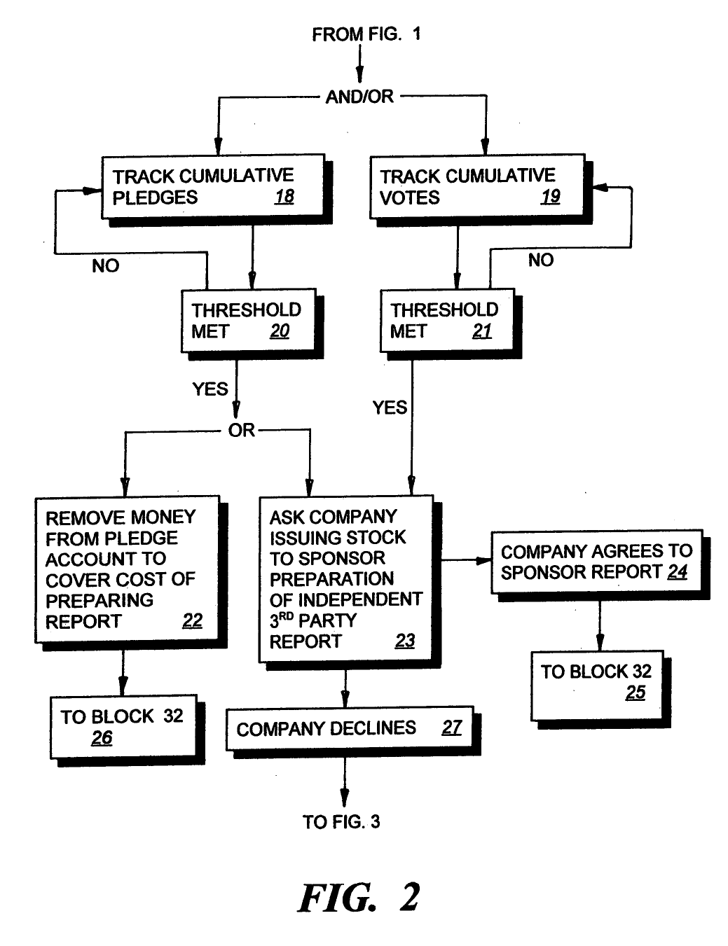

FIG. 2 is a block flow diagram further illustrating the system of FIG. 1;

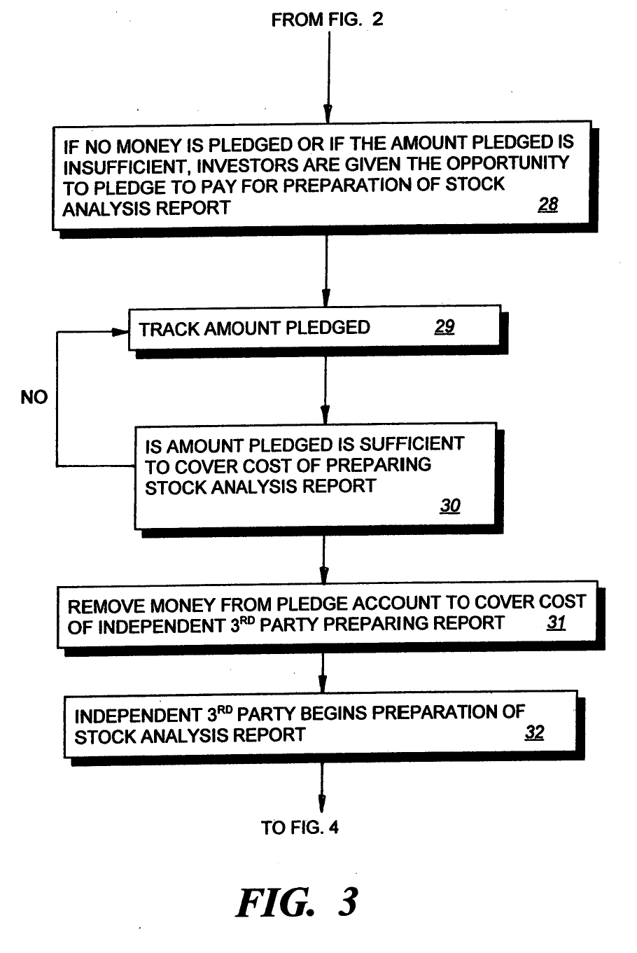

FIG. 3 is a block flow diagram further illustrating the system of FIG. 1;

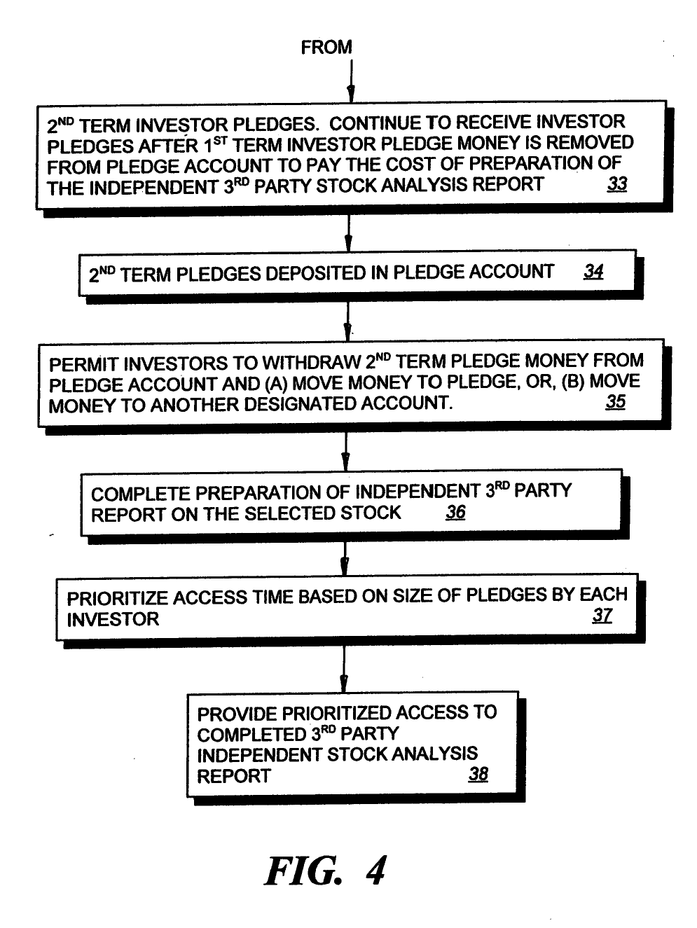

FIG. 4 is a block flow diagram further illustrating the system of FIG. 1; and,

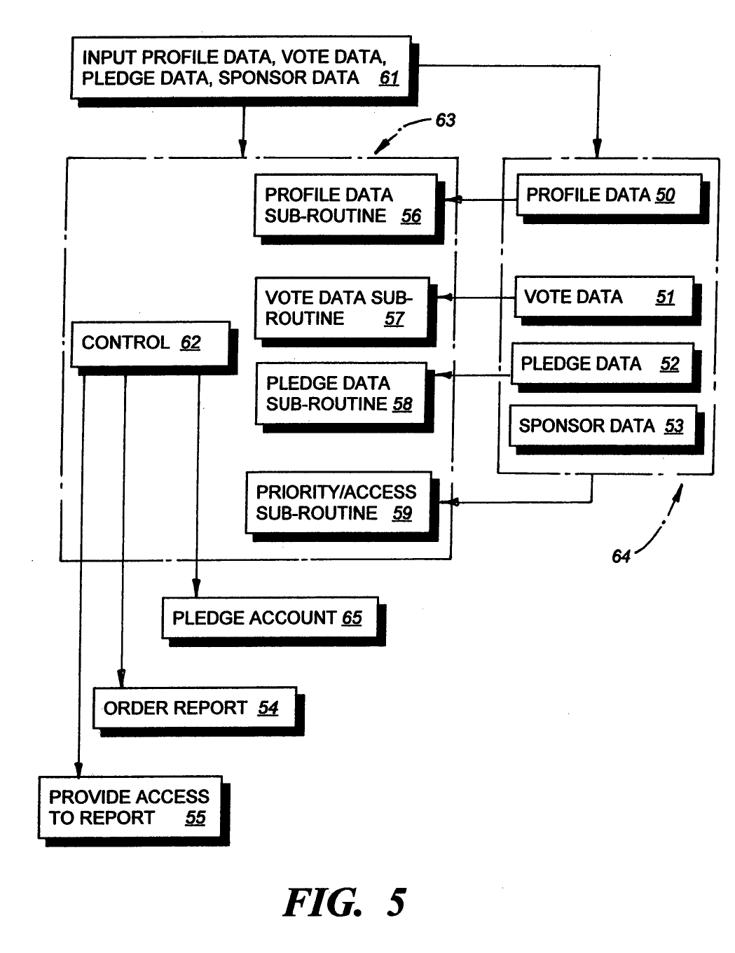

FIG. 5 is a block flow diagram illustrating the system of the invention.

Briefly, in accordance with the invention, I provide an improved business evaluation system to generate for a stock investor a financial report that evaluates a business entity offering stock for sale. The improved business evaluation system comprises a pledge account in which to deposit pledge money; and, a portal including a memory for storing for a plurality of stock investors profile data, and for storing the quantity of money pledged by each stock investor for the business entity. The memory also stores a pledge database containing the total pledge amount for the business entity. The portal also includes a computer operably connected to the memory and operable to receive for each stock investor profile data and the amount of money pledged by each stock investor for the business entity, to direct pledge money to the pledge account, and to determine when a threshold amount of pledge money is received for the business entity; includes a system to withdraw pledge money from the pledge account and to generate a completed independent evaluation report for the business entity when the threshold amount of pledge money is received; and, a system to permit access to the completed independent evaluation report by stock investors that contributed money to the pledge account.

In another embodiment of the invention, I provide an improved business evaluation system to generate for a stock investor a financial report that evaluates a business entity offering stock for sale. The business evaluation system comprises a portal including a memory. The memory stores for a plurality of stock investors profile data, and the number of votes by each stock investor for the business entity. The memory also stores a vote database containing the total votes for the business entity. The portal also includes a computer operably connected to the memory and operable to receive for each stock investor profile data and the number of votes by each stock investor for the business entity, operable to direct votes to said memory, and operable to determine when a threshold amount of votes is received for the business entity. The system also includes a system to generate independently of the business entity an independent completed evaluation report for the business entity when the threshold amount of votes is received; and, a system to permit access to the completed independent evaluation report by stock investors that votes for the business entity.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 to 5 illustrate a business evaluation system in accordance with the principles of the invention.

FIG. 5 provides an overview of one embodiment of the system of the invention, including a computer with a control 63 and a memory 64. Memory 64 includes investor profile data 50, vote data 51, pledge data 52, and sponsor data 53.

Profile data 50 includes investor profile data. This data 50 can vary as desired, but for each investor or other user typically includes the investor's name and address, telephone number, e-mail address, and the particular stock or stocks in which the investor is interested and for which the investor has either submitted a pledge or voted.

The vote data 51 includes the votes cast by investors in favor of having an independent evaluation report prepared for particular stocks (i.e., for the business entity that issues or sells a particular stock or other financial instrument).

The pledge data 52 comprises the money pledged by investors in favor of having an independent evaluation report prepared for a particular stock (i.e., for the business entity that issues or sells a particular stock or other financial instrument).

The sponsor data 53 includes the names of each business entity that has agreed to pay for the independent preparation of an evaluation report for that business entity, and includes the amount of money that the sponsor has pledged toward preparation of the independent evaluation report.

Control 62 includes profile data sub-routine 56, includes vote data sub-routine 57, includes pledge data sub-routine 58, and includes priority/access sub-routine 59. Profile data sub-routine 56 organizes and, as necessary, accesses profile data 50. For example, profile data 50 is accessed after an evaluation report is prepared and an investor's e-mail or telephone number is accessed to contact the investor to provide the investor access to the report.

Vote data sub-routine 57 organizes and, as necessary, accesses vote data 51. For example, sub-routine 57 accesses vote data 51 routinely to determine if a threshold number of votes has been received so that an independent evaluation report can be completed for a particular stock (i.e., for the business entity that issues and sells the stock).

Pledge data sub-routine 52 organizes and, as necessary, accesses pledge data 52. For example, sub-routine 52 periodically accesses pledge data 52 to determine if the threshold amount of pledge money has been received for a particular stock so that an evaluation report can be prepared for the business entity that issues or sells the stock.

Sponsor data sub-routine 53 organizes and, as necessary, accesses sponsor data 53.

Data 61 is input to control 62 and memory 64 at the portal. The data 61 includes investor profile data, vote data, pledge data, sponsor data, and any other desired data.

When an investor submits a pledge, the computer at the portal directs the pledge money to pledge account 65. This directing of money to account 65 can be accomplished electronically if, for example, an investor utilizes a credit card to submits a payment. The payment is directed by pledge data sub-routine 58 to account 65. Sub-routine 58 does this by requesting the credit card company to deposit electronically the money in account 65. Other ways that the computer at the portal can direct a pledge to account 65 are to have an investor direct wire the money into the account 65, or, to direct the investor to mail a check to the account 65.

When appropriate, the computer at the portal also notes that a report can be ordered 54, or, automatically sends out an order to an organization or individual that will conduct an evaluation and prepare a report for a selected business entity. The computer typically orders report 54 when a designated threshold is reached in votes and/or in pledge money. For example, a threshold of 1000 votes may have to be received before an independent report is ordered and prepared, or, a threshold of $10,000.00 in pledges may have to be received before an independent report is ordered.

After an independent evaluation report is completed, the computer at the portal provides access to the report 55 by directing that reports be e-mailed, mailed, or otherwise provided to an investor that pledged or voted to have the evaluation report prepared, or, by simply informing the investor that the report is available to be accessed and read or downloaded by the investor. If desired, individuals that did not pledge or vote to have the evaluation report prepared can also at some desired point be allowed access to the evaluation report. In one embodiment of the invention, access to the report is prioritized based on the amount of the money pledged by an investor or the number of votes cast by the investor for a particular business entity. For example, the investor (hereafter the “first place investor”) that pledged the greatest amount of money toward preparation of a report for a particular entity is notified first that the report is available. After the first place investor is notified, a period of time is allowed to pass before the second place investor is notified. The second place investor pledged more money than everyone except the first place investor. After the second place investor is notified, a period of time is allowed to pass before the third place investor is notified. The third place investor pledged more money than everyone except the first and second place investors. Accordingly, for a first period of time the first place investor has exclusive access to the report. Then for a second subsequent period of time subsequent to the first period of time, only the first and second investors have exclusive access to the report. Then for a third period of time subsequent to the first and second periods of time, only the first, second, and third investors have exclusive access to the report.

As utilized herein, an evaluation report is independently prepared if the business entity that is being evaluated by the report does not control the final content and form of the report. While the business entity about which the report is being prepared may provide information that is utilized in the report, the party preparing the report is independent of the company, and preferably is not paid by the business entity. The party preparing the report, and not the company being evaluated, makes the final decision about the substantive content of the report.

A more particular example of the system of the invention is set forth in FIG. 1 to 4.

As shown in FIG. 1, the first step in the system is to provide 10 a portal to receive investment data comprising investor profile data, votes, and pledges concerning the preparation of a report evaluating a selected stock or financial instrument (or of a report providing other information or evaluating another product or business or situation), i.e. concerning the preparation and evaluation of the business entity that issues or sells the stock or other financial instrument.

The second step in the system comprises opening 11 a pledge account in which monetary pledges for evaluation or analysis of a selected stock (i.e., for evaluation of the corporation, partnership, or other business entity selling the stock) are deposited.

The third step in the system is to define a threshold to initiate preparation of an evaluation or analysis report of a selected stock. This threshold comprises a certain number of votes that are required to be cast or received, or comprises a certain amount of pledge money that is required to be received to initiate an evaluation report for a business entity.

The next step in the system is to receive 13 investment data at the portal. The investment data typically comprises investor profile data 14, investor votes 15 cast for particular stocks, and 1^{st} term investor pledges 16. 1^{st} term investor pledges comprise pledges that are made prior to an evaluation report is ordered for a particular business entity. Pledges made after the evaluation report is ordered are termed 2^{nd} term investor pledges.

When investor pledges 16 are received at the portal, the pledges are deposited 17 in the pledge account. Investor votes 15 are stored in the memory 64 as vote data 51. Pledges made are also tracked and stored in memory 64 as pledge data 52 (FIG. 5).

FIG. 2 illustrates the next steps in the system of the invention illustrated in FIGS. 1 to 4. The vote data and pledge data sub-routines 57, 58 (FIG. 5) continuously periodically monitor 19, 18 (FIG. 2) the number of votes 51 and the amount of pledge money 52 donated for a particular stock.

If the cumulative number of votes for a stock or other financial instrument (i.e., for the business entity issuing or selling the stock) meets 21 the defined threshold, then the system moves on to step 23. If the cumulative number of votes for a particular stock does not meet or exceed the threshold, then control 62 continues to track 19 the number of votes for that stock.

Similarly, if the cumulative amount of pledge money for a stock meets 20 the defined threshold, then the system moves on to step 22 or 23. If the cumulative amount of pledge money for a particular stock does not meet or exceed the threshold, then control 62 continues to track 18 the amount of pledge money for that stock.

In step 23 (FIG. 2), the business entity that issues the stock is asked to sponsor the preparation of an independent 3^{rd} party evaluation or report about the company. Since a 3^{rd} party prepares the report, the business entity does not control the final content and form of the report

If the business entity agrees 24 to sponsor the report, then the business entity supplies some or all of the money necessary to prepare the report, and preparation 25 of the report is initiated as indicated in block 32 in FIG. 3.

Similarly, if the threshold for pledge money is met, then pledge money can be removed 22 from the pledge account to cover the cost or preparing the report, after which preparation 26 of the report is initiated as indicated in block 32 in FIG. 3.

If the business entity that is being evaluated declines 27 to sponsor the preparation of the independent evaluation, then, as shown in block 28 in FIG. 3, a determination is made to determine if sufficient money has been pledged to prepare the report. If sufficient money has not been pledged, then investors are given the opportunity to pledge sufficient money to pay for preparation of the independent report, and, the amount of money pledged is tracked 29 (FIG. 3). Once the amount of money pledged is sufficient 30 to cover preparation of the independent stock analysis report, then money is removed 31 from the pledge account and provided an independent 3^{rd} party to begin 32 (FIG. 3) preparation of the stock analysis report that evaluates the business entity that issues or sells the stock. The independent 3^{rd} party is anyone other than the business entity being evaluated and preferably other than any business entity that is a subsidiary of the business entity being evaluated or that is owned by or is otherwise controlled by the business entity being evaluated. The independent 3^{rd} party, and not the business entity being evaluated, makes all final decisions concerning the content and form of the evaluation report that is prepared.

FIG. 4 continues to illustrate the system of the invention. Once preparation of the stock analysis report begins 32, any pledges for the stock that are subsequently received are termed 2^{nd} term investor pledges 33 (FIG. 4). 2^{nd} term investor pledges, once made, can be removed from the pledge account at any time up until the stock analysis report issues and can be transferred to a pledge account for another stock or to any other designated account. Money pledged prior to the beginning of the preparation of the stock analysis report is, once the stock analysis report is begun, considered “spent” and can not again be removed from the pledge account or otherwise utilized by the investor.

In step 34 (FIG. 4), 2^{nd} term pledges are deposited 34 in the pledge account. As noted, and as described in block 35, 2^{nd} term pledge money can be withdrawn 35 from the pledge account and may deposited in a pledge account for another stock and in any other designated account. It is possible to deposit in a single pledge account monies pledged for a variety of stocks. In this scenario, pledge sub-routine 58 (FIG. 5) keeps track of which amounts in the pledge account are deposited for which stocks; and, consequently, this scenario is also considered equivalent to depositing pledge money for different stocks in “different” accounts.

Preparation of the independent 3^{rd} party stock analysis and evaluation report is completed in step 36. The independent 3^{rd} party is, as noted, not the business entity being evaluated. The independent 3^{rd} party has final say on the content and form of the evaluation report.

After the stock analysis-evaluation report is completed 36, sub-routine 59 prioritizes 37 the time-based release and access depending on the size of pledges given by each investor (or depending on any other desired criteria). For example, the investor that pledged the greatest amount of money is given first exclusive access to the report for a period of time (say 2 days by way of example, and not limitation); the investor that pledge second most is given second access for a period of time during which only the investors pledging first and second most have exclusive access(say for one day after the two days granted the investor that pledged the most), and so on. After the release and access time is prioritized 37, the investors are given access 38 (FIG. 4) according to the time release determined in step 37.

### EXAMPLE 1

A further example of the prioritization of exclusive access to the completed evaluation stock analysis-report is as follows.

Assume that there are ten registered investors. Four of the investors pledged a sum of money for a report on the business entity ABC, Inc. It is decided to distribute the completed report over a one week period, as follows:

| Investor | Pledge | Access Time |
|---|---|---|
| 1 | $100 | Exclusive access for 2.5 days. |
| 2 | $40 | Exclusive access (along with Investor 1) for 2 days |
| | | after the 2.5 day period of Investor 1 |
| 3 | $40 | Exclusive access (along with Investors 1 and 2) for |
| | | 2 days after the 2.5 day period of Investor 1 |
| 4 | $20 | Exclusive access (along with Investors 1 to |
| | | 3) for ½ day after |
| | | the combined 4.5 day period of Investors 1, 2 and 3 |
| 5 to 10 | $0 | Exclusive access (along with Investors 1 to |
| | | 4) for the 7 days after the combined five day period |
| | | of investors 1 to 4. |
| General | | Release to public after the combined |
| public | | twelve day period of Investors 1 to 10. |

In one embodiment of the invention, the portal comprises an Internet web site. Data is entered utilizing a keyboard or other conventional data entry system or apparatus.

In an alternate embodiment of the invention, the portal comprises an computer in a network. Data is entered utilizing a keyboard or other conventional data entry system or apparatus.

In still another alternate embodiment of the invention, the portal comprises a single computer. Data is entered utilizing a computer keyboard.

In another embodiment of the invention, investors or other individuals can for a price subscribe to the system of the invention to receive reports on all stocks (or on other topics or information desired) whether or not the subscriber voted for a specific stock or pledged money for a specific stock. In this system, the subscribers gain access to the reports after investors that did pledge money for the report, but before those individuals that registered or voted for the report but that were non-subscribers and that did not pledge money for the report. The more the subscriber pays, the more times he or she gets to vote for a particular stock or stocks. But, if desired, the number of times a subscriber or other person can vote for a particular stock can be limited.

In a further embodiment of the invention, an investor can pay for the ability to vote more than once to have a report prepared on a particular stock.

In still another embodiment of the invention, an investor can receive the ability to make additional votes as a reward for referring other individuals to participate in the system of the invention.

In still a further embodiment of the invention, the number of times investors can change their vote from one stock to another is, for a particular time period (i.e., a week, a month, etc.) limited.

In yet still another embodiment of the invention, a time value is purchased by an investor for a defined amount of money. For example, say that each dollar an investor pledges buys the investor one minute of exclusivity. Therefore, if an investor pledged $100.00 for a particular business entity, which was the greatest amount pledged, he would be first to receive access to the stock analysis-evaluation report for that business entity and would have exclusive access for a period of 100 minutes, after which the individual that pledged the next highest amount would receive access (The $100.00 investor would continue to receive access for as long as the investor wanted after the initial 100 minutes.).

In yet still a further embodiment of the invention, investor #1 pays the greatest amount per minute and gets single exclusivity for a period of time, investor #2 pays the next greatest amount per minute and, after investor #1's initial period of sole exclusivity passes, gets shared exclusivity with investor #1 for a selected period of time, and so on.

In an alternate embodiment of the system of the invention, an investor or other user of the system of the invention is, in order to entice the user to use the invention by voting or pledging funds, provided with information on what the stock analysis evaluation report for a company will contain and/or how information for the report is obtained. By way of example, and not limitation, the user can be informed that the report will, at least in part, be prepared using (1) a Dun and Bradstreet report on the financial status of the company, (2) a search of newspaper and judicial publications over the last 10 years to determine if the company has been involved or is involved in any potential lawsuits, (3) an Internet search to determine if any of the officers or directors of the company are involved in litigation or have served in other companies that experienced litigation during their term of service for the company, (4) the salaries and perks awarded the officers of the company and a discussion of whether such salaries and perks are reasonable and customary, (5) a search of publications to determine if the company is subject to a takeover bid and the affect such a bid might have on the stock price of the company, (6) a search of company or court records to determine if the company has ever filed for bankruptcy, (7) a visit, if permitted, to company facilities to interview company officials and employees, (8) a comparison of the performance of similar kinds of stocks over the past 10 years, etc. A discussion of how a stock analysis report (or other informational report) is prepared and what the report will contain and the benefit of such to a user of the system of the invention can significantly increase the value of the system of the invention to a user.

In another embodiment of the invention, companies that over a selected period of time, or by a certain deadline, receive the most votes from interested investors are given priority in terms of deciding which company should be pursued first to see if it wishes to sponsor the preparation of a report evaluating the company. For example, if 15,000 individuals are interested in potentially purchasing stock in a company and vote for a evaluation of the company to be undertaken, then such “pre-generated interest” can comprise a powerful incentive for the company to sponsor the preparation of an independent report on the company. If, on the other hand, only 500 individuals vote for a company, that generally will not provide a powerful incentive for a company to sponsor a report.

In a further embodiment of the invention, users can suggest (at a web site, for example) a research topic and vote for the topic and/or pledge money toward preparation of a report on the topic. For example, a user could suggest that a report be prepared on “LCD Industry Outlook for the Next Five Years” or “Where Will the Price of Gold be in Two Years”. Other users can view a list of such proposed topics at a web site and can then, if they wish, follow suit and vote or pledge money for the topic. In order to entice user to participate in a the preparation of a report on a particular topic, the web site can display the cumulative number of votes received to date or the cumulative amount of pledge money received to date and the threshold required for a report to be prepared. Once a sufficient amount of pledge money is received, the pledge money can be utilized to pay for preparation of the report.

In still another embodiment of the invention, the party or parties preparing an independent report of a company or for some other research topic remains anonymous.

In still a further embodiment of the inventions, the names of some or all of the individuals or entities that will use the independent report remain anonymous to the party or parties preparing the independent report.

As used herein, when reference is made to a “business entity offering stock for sale”, it is understood that this can refer to actual stock sold by a business entity in primary markets through underwriters, to bonds or other debtor financial instruments sold by said business entity in said primary markets, or to stock and other financial instruments that were originally owned or issued or sold by a first business entity and that are subsequently sold or traded by individuals or business entities on secondary markets like NYSE, AMEX, NASDAQ, etc. Consequently, a sale of a company's stock on NASDAQ from one individual to another individual constitutes a business entity offering stock for sale. A sale by a company of its stock on a primary market via an underwriter constitutes a business entity offering stock for sale. An so on. The purpose of the “stock sale” embodiment of the invention is to give individuals or institutions the ability to request an independent report on a company, regardless of whether the individuals or institutions are contemplating purchasing a company's stock or other financial instruments in a primary market or a secondary market. Similarly, as used herein, a stock investor is an individual or entity interested in purchasing stock or other financial instruments issued or offered for sale by a business entity. As used herein, an original business entity is the entity that first issued stock or another financial instrument. In many cases, an investor is interested in the original entity (i.e., Microsoft, Dell, AT&T, Kodak, Schwinn, Intel, etc.) that issued or sold stock; this because the stock or other financial instrument is being traded or bought and sold on secondary markets like the New York Stock Exchange and NASDAQ.

One particular advantage of the system of the invention is that, by fostering the preparation of independent evaluations of companies that issue or offer for sale stock or other financial instruments, it minimizes or eliminates the likelihood of conflicts of interest of the type addressed in Section 501 I connection with the treatment of securities analysts by registered securities associations. Section 501 amends Section 15A of the Securities Exchange Act of 1934.

Having described my invention in such terms as to enable those of skill in the art to understand and use it, and having described the presently preferred embodiments and best mode thereof, I claim:

1. A business evaluation system to generate for a stock investor a financial report that evaluates an original business entity offering stock for sale, the business evaluation system comprising
(a) a pledge account in which to deposit pledge money;
(b) a portal including
(i) a memory for storing for a plurality of stock investors profile data, and
the quantity of money pledged by each stock investor for the original business entity,
said memory also storing a pledge database containing the total pledge amount for the original business entity,
(ii) a computer operably connected to the memory and operable to receive for each stock investor profile data and the amount of money pledged by each stock investor for the original business entity,
direct pledge money to the pledge account, and
determine when a threshold amount of pledge money is received for the original business entity;
(c) a system to withdraw pledge money from the pledge account and to generate independently of the original business entity an independent completed evaluation report for the original business entity when the threshold amount of pledge money is received; and,
(d) a system to permit access to the completed independent evaluation report by stock investors that contributed money to the pledge account.

2. A business evaluation system to generate for a stock investor a financial report that evaluates a business entity offering stock for sale, the business evaluation system comprising
(a) a portal including
(i) a memory for storing for a plurality of stock investors profile data, and
the number of votes by each stock investor for the business entity,
said memory also storing a vote database containing the total votes for the business entity,
(ii) a computer operably connected to the memory and operable to receive for each stock investor profile data and the number of votes by each stock investor for the business entity,
direct votes to said memory, and
determine when a threshold amount of votes is received for the business entity;
(c) a system to generate independently of the business entity an independent completed evaluation report for the business entity when the threshold amount of votes is received; and,
(d) a system to permit access to the completed independent evaluation report by stock investors that votes for the business entity.
